(19) United States
(12) Patent Application Publication
(10) Pub. No.: US 2025/0314527 A1
(43) Pub. Date: Oct. 9, 2025

(54) DETECTOR SCHEME FOR DETECTING LASER VOLTAGE PROBING ATTACKS

(71) Applicant: NATIONAL UNIVERSITY OF SINGAPORE, Singapore (SG)

(72) Inventors: Hui ZHANG, Singapore (SG); Longyang LIN, Singapore (SG); Massimo ALIOTO, Singapore (SG)

(73) Assignee: NATIONAL UNIVERSITY OF SINGAPORE, Singapore (SG)

(21) Appl. No.: 18/873,185

(22) PCT Filed: Jun. 9, 2023
(86) PCT No.: PCT/SG2023/050413

§ 371 Date: Dec. 9, 2024

(30) Foreign Application Priority Data
Jun. 9, 2022 (SG) 10202250104G

(51) Int. Cl. G01J 1/42; G01J 1/44; G01R 19/165

(52) U.S. Cl. CPC G01J 1/4257; G01J 1/44; G01R 19/16571; G01J 2001/4446

(57) ABSTRACT

Disclosed is a sensor fabric for detecting an attack on transistors. The fabric includes a plurality of sensor clusters. Each sensor cluster comprises a plurality of photodetectors and transistors, each photodetector being disposed next to a respective said transistor, a standard cell and an aggregator. The standard cell comprising a thresholding comparator for comparing a first input from a first group of the photodetectors of the respective cluster and a second input from a second group of the photodetectors of the respective cluster, the first input and second input being proportional to incident light sensed by the respective photodetectors, and flipping an output of the standard cell if a difference between the first input and second input exceeds a predetermined threshold. The aggregator aggregates the outputs from the clusters to produce an aggregated output, and triggering an alarm on detection of an attack based on the aggregated output.

### TECHNICAL FIELD

The present invention relates, in general terms, to a detector scheme for detecting laser voltage probing (LVP) attacks on transistor arrays. More particularly, the invention relates to, but is not limited to, a sensor fabric for design-agnostic LVP attack detection, providing full area coverage.

### BACKGROUND

In recent times, on-chip data security is threatened by a range of physical attacks ranging from non-invasive to (semi) invasive. Although more laborious, the latter are generally more effective in retrieving on-chip secrets. Among them, laser voltage probing (LVP) has recently gained a strong interest due to its high success rate. LVP attacks basically establish a physical side channel by shining a laser beam on a specific net from the die backside, and retrieving its voltage via time-averaged observation of the backscattered signal. The LVP attack cost and effort has dropped to minutes (and up to a few hours) at an hourly rate of ˜$1,000 in laboratories providing reliability and failure analysis services for silicon debugging. This has made such attacks easily accessible, deployable, and vastly less expensive than the potential value stored on chips (e.g., cold storage wallet for blockchain for cryptocurrency and NFTs). LVP attacks are systematic and circumvent most countermeasures, as the latter mostly protect the die frontside.

Since LVP attacks target the die backside and have excellent spatial resolution down to individual nets (electrically connected shapes on conducting layers such as polysilicon and metal layers), on-chip counteraction is challenging and requires costly customization in the manufacturing (e.g., via optical scrambling) or packaging process (e.g., via optical coating participation to the encryption).

Process customization was also explored to detect bulk thickness changes determined by die preparation for LVP, though disallowing attack detection at above-bandgap wavelengths (>1.1 μm) without silicon removal, and routine wafer/die post-processing (e.g., backlapping for in-package system integration). Backside custom coating was also explored to detect intrusion, though it requires impractical and power-hungry on-chip light-emitting diodes.

On-chip LVP attack detection has also been investigated. Although easier than counteraction, LVP remains more challenging than for other laser-based attacks such as laser fault injection (LFI). Other schemes for LVP attack detection have been contemplated. Self-timed sensors were recently demonstrated for static signals. Ring oscillators were used to monitor standard cells in their neighbourhoods, but with full area coverage unfeasible under practical power/area budgets. Concealing gates were explored but easily circumvented by sub-cell spatial resolution. Cell-based detection but such schemes could not sense above-bandgap wavelengths used in LVP attacks.

In contrast to LFI attacks, LVP attacks aim to keep the circuit largely unperturbed when exposed to the laser beam. This requires the adoption of much weaker laser power, above-bandgap wavelengths, and precise laser spot down to single transistor. These make detection much harder.

Overall, no LVP detection with full-area coverage, unaltered manufacturing/packaging process, adequate sensitivity both above- and below-bandgap wavelength and fully-automated design is available.

It would be desirable to overcome or ameliorate at least one of the above-described problems with current schemes for detecting LVP attacks, or at least to provide a useful alternative.

### SUMMARY

Embodiments of a sensor fabric (set of regularly placed photosensors on chip, where the chip may have other components such as transistors) presented herein provide a design-agnostic LVP attack detection scheme with always-on and full area coverage. Photosensor embedment within standard cells allows full-area coverage and automated design, while preserving the geometry of on-grid transistor gate polygons for unrestricted adoption in physical design flows, and process scalability. Decision margin and sensitivity are shown to be more than adequate for any practical level of incident laser power necessary to mount such attacks.

The present invention provides a sensor fabric for detecting an attack on transistors. The fabric includes a plurality of sensor clusters. Each sensor cluster comprises a plurality of photodetectors and transistors, each photodetector being disposed next to a respective said transistor, a standard cell and an aggregator. The standard cell comprising a thresholding comparator for comparing a first input from a first group of the photodetectors of the respective cluster and a second input from a second group of the photodetectors of the respective cluster, the first input and second input being proportional to incident light sensed by the respective photodetectors, and flipping an output of the standard cell if a difference between the first input and second input exceeds a predetermined threshold. The aggregator aggregates the outputs from the clusters to produce an aggregated output, and triggering an alarm on detection of an attack based on the aggregated output.

Embodiments described herein thus introduce an on-chip detection scheme against LVP attacks. The photodetector spacing achieves 100% area coverage by inserting photodetectors (pn junctions) into each standard cell next to each transistor. As used herein, the term “next to”, when used with reference to a photodetector being next to a transistor, refers to a photodetector being adjacent a transistor or sufficient close to a transistor that there is no circuitry therebetween or sufficiently close to detect an incident laser spot of a predetermined size. Similarly, the term “neighbouring” or “next” may refer to a nearest component—e.g. a neighbouring photodetector is the closest photodetector.

Advantageously, embodiments provide on-chip LVP attack detection with 100% area coverage. LVP attacks with a best-in-class laser spot size of 220 nm on a protected advanced encryption scheme/standard (AES) on-chip core are very powerful.

Advantageously, embodiments of the sensor fabric cover both above- and below-bandgap laser detection. Detection of LVP attacks with laser wavelength up to 1319 nm which is above silicon bandgap (˜1.1 eV) is achievable in such embodiments, with below-bandgap detection being inherently achieved by the present silicon-based photodetector schemes.

Advantageously, the design permits a fully-automated standard-cell based design. This facilitates wife adoption, and system integration, since there is little or no modification to production methodology and, in some embodiments, only a change of form factor in one direction—along Vₛₑₙₛₑ line or channel.

### BRIEF DESCRIPTION OF THE DRAWINGS

Embodiments of the present invention will now be described, by way of non-limiting example, with reference to the drawings in which:

FIG. 1 is an embodiment of the proposed on-chip LVP detection scheme comprising a standard cell-based laser photodetector fabric;

FIG. 2 is an example of a standard photosensitive standard cell for incorporation into the detection scheme of FIG. 1;

FIG. 3 illustrates Gaussian laser intensity spatial profile of a best-in-class LVP laser spot size (1,319 nm wavelength, full-width at half maximum FWHM <220 nm);

FIG. 4 shows the geometrical considerations on photodetector placement in a photosensitive standard cell; and

FIGS. 5a to 5h show experimental measurements performed on process variations across 128 photodetector cluster arrays, with histogram readouts of sensed voltages on Vₛₑₙₛₑ with and with LVP attack and AES running in ambient light, where FIGS. 5a to 5d are the results for a N_{cluster}=17 array across laser power, supply voltage and wavelength, and FIGS. 5e to 5h are the results for 10 a N_{cluster}=102 array across laser power, supply voltage and wavelength.

### DETAILED DESCRIPTION

Under the adoption of an LVP detection scheme as described herein, a drastic reduction in the LVP laser power is required for a successful undetected attack. In many or all cases, the laser power is necessarily below the sensitivity needed for the attack, thereby precluding success. Moreover, lowering the laser power quadratically increases the LVP attack time. This increase in LVP attack time is upper bounded by values around several hours, after which the attack is unsuccessful. The effects of long exposure are known from common practices in laser voltage probing for reliability and failure analysis. Indeed, longer attacks (e.g., a significant fraction of a day) are well known to be unfeasible due to drifts in equipment (e.g., focus, stage instability) and slow thermal expansion in die and optics (e.g., solid immersion lens).

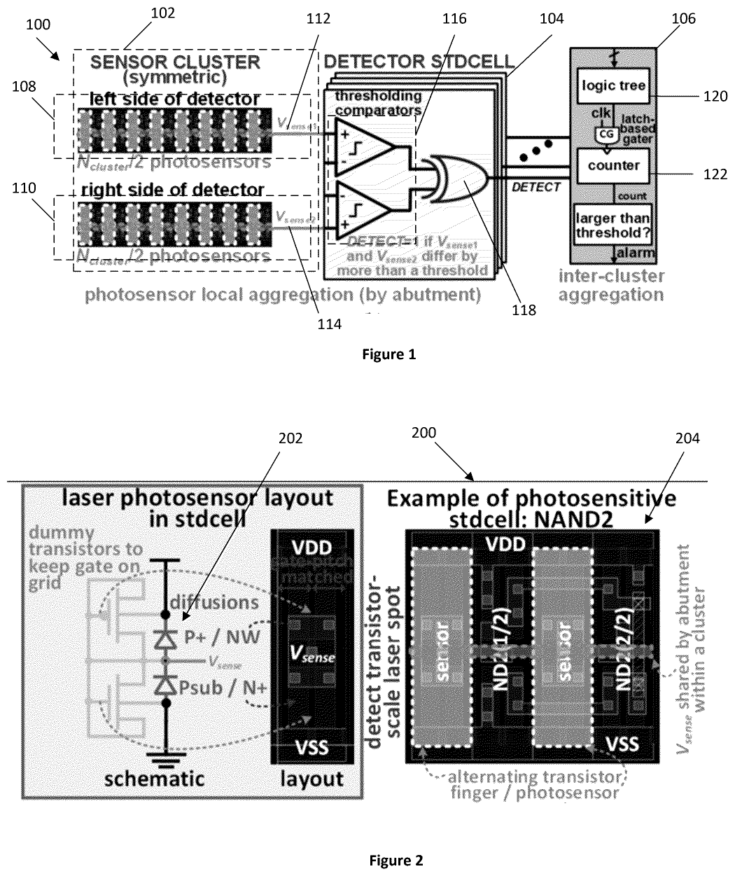

With reference to FIG. 1 a sensor fabric 100 is used for detecting an attack, particularly an LVP attack, on transistors. The sensor fabric 100 includes a number of clusters 102 of photodetectors and transistors, a detector standard cell 104 and an aggregator 106. In the embodiment shown in FIG. 1, multiple detector standard cells 104 are provided, one for each cluster 102, all of which feed into a single aggregator 106. Notably, the aggregator 106 may have any design, and may comprise a single circuit as shown or other circuits that feed an output to an aggregating circuit to achieve the aggregating function described below. All such embodiments will be apparent to the skilled person in view of the present disclosure.

Each cluster 102 is formed from multiple photosensitive standard cells 200, one of which is shown in FIG. 2. Each photosensitive standard cell 200 includes one or more photodetectors next to a respective transistor. The photosensitive standard cell 200 of FIG. 2 includes two photodetectors 202 alternating with transistor fingers 204. Each transistor finger comprises one or more transistors for recording data.

There may be a one-to-one relationship between the photodetectors 202 and transistor fingers 204. However, the spacing between photodetectors 202 may otherwise be determined based on an anticipated or predetermined spot size of a laser used in a LVP attack, as discussed below.

Each cluster 102 may comprise a first group and a second group of photodetectors—the groups may have the same number of sensor standard cells, or may have different numbers thereof. In the embodiment shown in FIG. 1, each group (first group 108, second group 110) comprises one or more, and presently many, photosensitive standard cells. No photodetector is in more than one group. The photodetectors are in electrical communication over a sensing line, Vₛₑₙₛₑ₁ (112) in respect of the first group 108 and Vₛₑₙₛₑ₂ (114) in respect of the second group 110. The first group 108 and the second group 110 provide a respective input along Vₛₑₙₛₑ (112) and Vₛₑₙₛₑ₂ (114) to a thresholding comparator 116 of the detector standard cell 104.

The comparator 104 compares a first input received along Vₛₑₙₛₑ₁ (112) and a second input received along Vₛₑₙₛₑ₂ (114) to identify a difference in the first a second inputs. In advance of the comparison, the detector standard cell 104 may amplify the first input and/or second input at amplifying stage 116, which presently comprises an operational amplifier (OpAmp) for each sensing line. The comparison is performed by any appropriate circuit, presently XOR gate 118. If the outputs are the same, the XOR gate 118 will output a zero (LOW) and will otherwise output a 1 (HIGH). The output of the detector standard cell 104 is therefore flipped—e.g. from low to high-if the difference between the first input and second input exceeds a predetermined threshold—e.g. a threshold sufficient for one of the inputs to be considered LOW and the other input to be considered HIGH.

In other words, the detector standard cell 104 compares Vₛₑₙₛₑ across N_{cluster} photodetectors connected to it on its left (first group 108), and N_{cluster} on its right (second group 110). As in FIG. 1, the detector standard cell 104 is a pair of 2-stage comparators—the first stage (116) compares the relevant Vₛₑₙₛₑ line to ground (or a reference value) and amplifies any difference, and the second stage (118) compares the now amplified differences to each other—that flips its output when the difference between the left/right half clusters is above a decision threshold or predetermined threshold. The same decision threshold may be adopted throughout the detector standard cells, regardless of the sensor cluster size. This shows that the parameters defining the architecture (e.g., Ngate pitch, Ncluster) can be set or fixed at design time. Consequently, no calibration is required.

After incident laser spot detection is confirmed, or otherwise, by each detector standard cell, the aggregator 106 then aggregates the outputs from the clusters—these outputs being outputted from the respective detector standard cell as either a LOW or HIGH comparison result—to produce an aggregated output. The aggregated output triggers an alarm on detection of an attack based on the aggregated output. The detection may be that the number of detector standard cells with a HIGH output (or LOW output in some embodiments) exceeds a predetermined threshold, thereby indicating that the clusters associated with the HIGH (or LOW) detector standard cell outputs are receiving incident laser.

Embodiments of a sensor fabric, such as sensor fabric 100, presented herein provide a design-agnostic LVP attack detection scheme. The detection scheme is always-on—the output is only produced on application of incident laser light—and provides full area coverage. Photodetector (also referred to as photosensor) embedment within standard cells allows full-area coverage and automated design, while preserving the geometry of on-grid transistor gate polygons for unrestricted adoption in physical design flows, and process scalability. Sensor outputs are locally aggregated by abutment through automatically placed and routed detector standard cells, whose outputs are finally aggregated-aggregation may be through an automatically synthesized logic tree that generates the system-level attack detection flag from the sensor-level flags or other mechanism.

The decision margin and sensitivity, particularly after amplification at stage 116, are shown to be more than adequate for any practical level of incident laser power necessary to mount such attacks. The ability to detect the laser beam on chip and at run time forces the adversary to reduce the laser power during the attack. In turn, this forces signal-to-noise ratio (SNR) degradation in the detected reflected beam below the sensitivity of the proposed detection scheme, and hence a quadratic increase in the attack time to a level where equipment drifts and thermal expansion dominate. In this case, no SNR improvement is achieved when prolonging the attack time further, and hence no knowledge of on-chip targeted voltages is gained from the attack.

With further regard to the clusters 102, the photodetectors 202 are spaced at intervals sufficient for full area coverage (i.e. visibility of a LVP attack on any transistor in the sensor fabric). In practice, this means photodetectors 202 must be spaced based on an anticipated or predetermined laser spot size. The spot size may be the diameter of the incident laser light. For full area coverage, the photodetectors must be spaced so that there is no space on the sensor fabric that is the size of the predetermined laser spot or larger that does not include at least one photodetector 202.

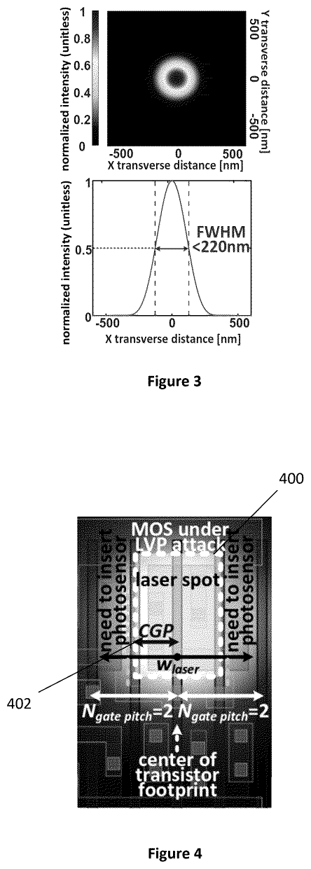

To keep each LVP sensor within one laser spot size of the next one under standard cell discipline, from FIG. 4a it is necessary to place one photodetector 202 in a regular pattern with an inter-photosensor distance of a suitable number of gate pitches N_{gate pitch} such that the laser spot can be detected at any location on chip under common laser beams with Gaussian-distributed power density:

$${N}_{gate pitch} \leq {w}_{laser} / CGP = 1.7 \cdot FWHM / CGP \qquad ( 1 )$$

where wlaser is the laser spot size, and CGP is the contacted gate pitch set by the layout design rules and the standard cell architecture. Since the laser is Gaussian spatially distributed, the laser spot size in (1) is defined as the diameter at ±2 standard deviations or equivalently 1.7±FWHM, where FWHM is the full-width at half-maximum power in FIG. 3, which shows the normalised intensity relative to transverse distance from a centre of the laser spot—the top figure is in plan view and the bottom figure shows the Gaussian distribution across an area, through the centre of the laser spot. Placement of the photosensors or photodetectors can be adjusted depending on the transistor layout, to provide full area coverage as will be appreciated by the skilled person in view of the present teachings.

The current best-in-class available FWHM in (1) at above-bandgap wavelengths is 200-220 nm. That diameter is therefore used in the attack setup of experiments described below.

At 28 nm, Ngate pitch in (1) resolves to 2 as in the example in FIG. 3, i.e. the photosensors need to be placed next to each transistor as in FIGS. 1 and 2. The FWHM of laser beam is 200-220 nm, an upper limit for the best case value Of N_{gate_pitch}. So, FWHM is 220 nm. Consequently, Wₗₐₛₑᵣ is 220 nm*1.7, which is 374 nm. CGP under the 28 nm is 140 nm (the poly gate pitch). So, 374 nm/140 nm yields 2.67. So, N_{gate_pitch} <2.67, so we take 2. This ensures full area coverage with potentially some overlap.

In summary, we need to have a photosensor every two gate pitch, which means that, we need to place a sensor next to each transistor gate, as shown in FIG. 2. This is schematically represented in FIG. 4, showing an incident laser spot on a MOS 400, the CGP 402 and maximum distance for a photodetector being 2×CGP. For more advanced technologies, the right-hand side of (1) will increase due to the reduction in CGP with smaller transistors dimensions. Hence, the density of sensor placement is relaxed and sparser (i.e., Ngate pitch >2). This reduces the percentage area overhead. The ratio of photodetectors to transistors becomes lower for a given laser spot size, since the photodetector maximum distance is fixed by the laser spot size whereas the gate pitch shrinks in finer technologies. In turn, this means that more transistors can be placed between adjacent photosensors at finer technologies. These considerations hold for each PMOS and NMOS pair sharing the same gate, inserting a pair of photodetectors in the same gate pitch slot next to them as in FIG. 2.

Placement of photodetectors may differ between clusters or may be consistent across clusters—i.e. may be the same for all cells in an LVP-aware sensor fabric as in FIGS. 1 and 2. Digital circuits are routinely designed with a “cell library”, which is just a collection of basic cells (in general these are essentially logic gates). An “LVP-aware cell libray” means that the photosensors are embedded into each standard cell, thus making the entire library “LVP-aware”. In other words, the sensor fabric is built by placing standard cells, which in turn embed photosensors within themselves (in other words, the sensors are part of the standard cells, and can also be additional/separate standard cells). The type of photodetector may depend on the type of transistor. For example, the photodetectors may form a reverse-biased pn junction. In this regard, the photodetectors are p+/n-well diffusions for PMOS transistors and n+/p-body diffusions for NMOS transistors.

Placement of photodetectors in the scheme set out above preserves sensor density and maximises the distance of each transistor to the closest sensor when flipping the cells vertically during physical design. Horizontal cell flipping is instead disabled at the placement stage to maintain regularity in the sensor pitch across abutting cells. Filler cells are also equipped with photodetectors for sensor fabric continuity. The sensor fabric is simultaneously fabricated with the detector and logic circuits aggregating the photosensors outputs, since the photosensors are made up of the same fabrication layers as transistors.

The resulting standard cell architecture in FIG. 2 enables the design to remain fully automated, and naturally incorporates restricted design rules for correct-by-construction layout. Relating to full automation, the standard cell architecture needs to be modified to incorporate the photosensors. However, standard cells are usually building blocks that are made available to designers by the foundry or third-party vendors, and hence do not entail any design burden for the designer (they just use an existing standard cell library, which has been purposely enriched with photosensors). The cell-level area overhead under the sensor density in FIG. 2 ranges from 100% to 240%. The overhead differs across cells due to the different count in shared diffusions to be split. The area overhead depends on the specific cell into which the photosensors are incorporated, as determined by the number of shared diffusions that need to be interrupted to insert a photosensor—i.e. if a diffusion needs to be interrupted, the area overhead becomes higher. For example, in a minimum sized inverter gate, the area is only doubled by placing a sensor next to its gate whereas for larger cell, e.g., D-type flipflop, the shared diffusions need to be split to accommodate the sensors.

The sensors can be of any appropriate type. With regard to LVP attacks, detection with full-area coverage requires sensors with better sensitivity than bulk built-in current sensors (BBICS), down to a level that can detect laser at above-bandgap wavelength and minimal available power to mount attacks. Moreover, the design scheme set out herein can enable detection of LVP attacks at laser power levels at which the required number of acquisitions for adequate SNR is impractically high—this makes LVP probing (i.e. attacks) unfeasible. The photodetectors (i.e. sensors) should also be able to be integrated in-situ such that they are densely distributed within a laser spot distance for every single transistor in the sensor fabric area. Moreover, distribution of photodetectors should be within the logic being protected—i.e. on-chip—and thus, ideally, be compatible with standard cell-based design flows. For example, one or more dummy transistors may be inserted for each photodetector, to maintain a geometry of the group comprising the photodetector.

For the pn junction photodetectors described herein, Table I sets out the cell area and current leakage overhead due to the positioning of photodetectors.

TABLE I

| | | | Average | | | | Average |
|---|---|---|---|---|---|---|---|
| | Protected cells | Area | leakage | | Protected cells | Area | leakage |
| Combination | inverter | +100% | +0.77% | Sequential | D flip-flop with | +240% | +1.84% |
| logic cells | NOR2 | +167% | +0.73% | cells | asynchronous reset | | |
| | NAND2 | +167% | +0.57% | | D flip-flop | +229% | +1.80% |
| | buffer | +167% | +0.64% | | | | |

Once the spacing is determined and all photosensitive standard cells are equipped with photodetectors as set out in FIG. 2, a sensor fabric is automatically built by synthesizing, placing and routing the above photosensor/photodetector-enriched photosensitive standard cells 200 into a single circuit. The 202 photosensor outputs are hierarchically aggregated based on spatial proximity via abutment to keep extra routing minimal in spite of their high density. In particular, cell abutment automatically creates a common Vsense horizontal line in metal 2 that extends across adjacent cells, since it is embedded in each cell and covers its full width as in FIG. 2.

Connection by uninterrupted abutment, namely the respective Vₛₑₙₛₑ line, creates local clusters of N_{cluster} adjacent sensors in the same row per cluster 102 in FIG. 1. Each cluster includes a detector standard cell 104 that interrupts the Vsense wire (hance that wire can be described as two separate input lines, Vₛₑₙₛₑ₁ and Vₛₑₙₛₑ₂) to achieve the desired cluster size. The detector standard cell 104 then translates Vsense into a digital attack occurrence flag by performing comparison of the two inputs along Vₛₑₙₛₑ. The detector cells are pre-placed at regular locations at regular intervals every N_{cluster} photodetectors.

The automated digital design flow is nearly unaffected by the above methodology, as the only difference lies in the pre-placement of the detector cells, and the cell flipping restriction to the horizontal dimension during fabrication. The regular comparator is biased with the leakage current of another transistor, eliminating any explicit bias voltage. Comparators may also be designed and incorporated into standard cells in other ways. This current is enough to capture multi-ms scale laser pulses commonly adopted in LVP attacks.

Inter-cluster aggregation of the digital outputs from the detector standard cells is performed via a simple logic tree. The logic tree (120 in FIG. 1) consolidates the pulse occurrences at any one point in time, and the counter 122 captures the pulse occurrences over time. Once the counter value exceeds a predetermined threshold, an alarm circuit 124 triggers an alarm. The counter may be reset after particular period of time, so that the alarm is flagged only if there is a significant (i.e., above a threshold) number of pulse occurrences within a predetermined or application dependent time period. The logic tree 120 is automatically placed and routed based on a script-generated netlist.

In experiments, a test chip was designed and fabricated in 28 nm CMOS with flip-chip packaging. The test chip incorporates test structures including a detector standard cell and a cluster array with Ncluster=17, 34, 68, 102, and their readout circuitry (i.e., analog buffers and multiplexers) to individually access each of the 128 instances. Five 128-bit AES cryptographic cores were designed including an unprotected baseline design, and four versions of the protected AES core with Ncluster=17, 34, 68 and 102. All AES cores were designed with a conventional digital design flow via additional detector cell pre-placement scripts.

After fabrication, the die was thinned down to 100-μm thickness on its backside through backlapping for optical coupling with the solid immersion lens (SIL) used in the LVP testing equipment. The backside surface roughness was kept at ±3 μm to minimize any gap between the die and the SIL, and hence achieve a circular undistorted laser spot with pre-defined FWHM (i.e., spatial resolution when transferring the beam to the die). The effect of ambient light on attacks is expectedly insignificant since the chip area of the test chip under attack is blocked by the SIL.

In view of its transistor-scale spatial precision requirement, LVP equipment is vastly more sophisticated than for simpler LFI attacks in most prior literature, and mandates:
the presence of the SIL to preserve laser beam focus across the whole optical path, instead of objective lens only
continuous-wave laser with long pulses (e.g., ms scale) to probe reasonably long waveforms for later time alignment and signal recovery, instead of simple pulsed laser
lab load-bearing structure to host a vibration isolation table with weight in the 500 kg range (416 kg/m)
transverse mechanical support of silicon die on board to accommodate for ˜20-N force for stable SIL attachment.

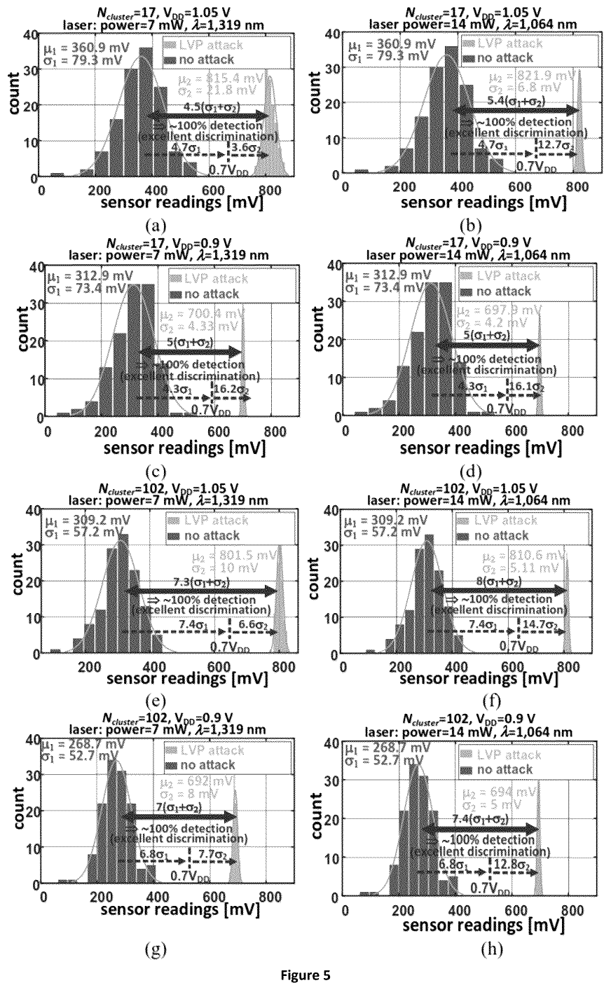

The test chip was extensively characterized with ˜150 hours of LVP testing. On-chip sensors were first measured under different sensor cluster size Ncluster, laser wavelength above and below bandgap (1,319 nm and 1,064 nm), and supply voltage. For each value of Ncluster, a sensor array with 128 instances was characterized to prove the robustness of the sensing scheme down to the single sensor. The measurements in FIGS. 5a-5h show the effect of mismatch on Vₛₑₙₛₑ across 128 clusters under the same exposure conditions during the AES execution. For the lowest Ncluster=17, FIG. 5a reveals that Vsense can reliably discriminate the occurrence of an attack with a worst case decision margin of 4.5 standard deviations (i.e., false positives/negatives with probability of 3.4E-6) at the lowest allowed laser power of 7 mW, nominal supply voltage of 1.05 V and above-bandgap wavelength. The decision margin expectedly increases at the doubled 14-mW laser power and below-bandgap wavelength, as in FIG. 5b. Very similar holds at 0.9-V supply voltage in FIGS. 5c and 5d, with the decision margin being still robust and exceeding 5 standard deviations in spite of a voltage fluctuation (−15%) exceeding actual voltage variations in practical designs.

A higher Ncluster simultaneously improves area overhead, sensitivity and decision margin (attack/no-attack). Indeed, higher Ncluster leads to a sparser placement of detectors (detector standard cells), as each of them serves 2Ncluster sensors. Regarding the sensitivity, FIGS. 5e-5h experimentally show that the average difference in Vdsense at Ncluster=102 under attack/no-attack increases by ˜40 mV, compared to Ncluster=17 across supply voltages, laser power and wavelengths. Regarding the decision margin, higher Ncluster also mitigates the effect of mismatch, due to the mismatch averaging effect across a larger number of parallel-connected sensors. This is confirmed by the ˜15% reduction in the Vsense variability under no attack in FIGS. 5a-5h, and ˜1.5× improvement in the decision margin under Ncluster=102 compared to 17. Overall, this suggests that reasonably high values of Ncluster should be adopted to achieve better area efficiency, mismatch mitigation and hence decision margin.

The above ample decision margin expectedly enables correct detection under voltage scaling well below 0.9 V, and down to 0.5 V regardless of the wavelength. The missed detection at 0.4 V is due to the detector noise margin degradation at such low voltages. Overall, these considerations make the adoption of the higher Ncluster=102 preferable from all points of view.

The effect of temporal noise on Vdetect was also experimentally studied by carrying out measurements over 50,000 repetitions. The AES execution was maintained to correctly include circuit activity and the related possible noise contributions. The overall decision margin ranges from 11.5 to 12.8 standard deviations, making false positives and false negatives insignificant. This is achieved thanks to the robust margin in Vsense, and the additional effect of the CMOS logic-like non-linearity in the detector circuit input-output characteristics that further constricts Vdetect towards either very low values close to ground, or high values close to the supply voltage. Overall, this means that the decision margin is essentially limited by mismatch rather than noise.

Compared to prior art, the present scheme uniquely enables laser detection at all times, above the bandgap wavelength and full-area coverage under state-of-the-art deep sub-μm laser spots. The scheme was incorporated in a fully automated digital design methodology for design-agnostic and easy adoption. The area overhead to achieve such high level of security is high (up to 150%) if indiscriminately applied to the entire chip, and is substantially reduced in practical cases where the information-sensitive sub-system is a portion of the entire system (e.g., <20% for a secure AES coupled with an ARM Cortex-M4 processor). The power and performance overheads are insignificant. As another unique capability, the proposed scheme does not impose any significant restriction on voltage scaling, as shown in the 0.5-1.05 V range.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A sensor fabric for detecting an attack on transistors, comprising:
a plurality of sensor clusters each sensor cluster comprising:
a plurality of photodetectors and transistors, each photodetector being disposed next to a respective said transistor;
a standard cell comprising a thresholding comparator for:
comparing a first input from a first group of the photodetectors of the respective cluster and a second input from a second group of the photodetectors of the respective cluster, the first input and second input being proportional to incident light sensed by the respective photodetectors; and
flipping an output of the standard cell if a difference between the first input and second input exceeds a predetermined threshold; and
an aggregator for aggregating the outputs from the clusters to produce an aggregated output, and triggering an alarm on detection of an attack based on the aggregated output.

2. The sensor fabric of claim 1, wherein, for each cluster, the first group of photodetectors and the second group of photodetectors each comprise half of the photodetectors in the cluster.

3. The sensor fabric of claim 2, wherein each photodetector is in exactly one of the first group and second group.

4. The sensor fabric of claim 1, wherein the thresholding comparator is biased with the leakage current of another transistor.

5. The sensor fabric of claim 1, wherein each photodetector comprises a reverse-biased pn junction.

6. The sensor fabric of claim 1, wherein the aggregator aggregates the outputs using a logic tree.

7. The sensor fabric of claim 1, wherein the aggregator:
keeps a count of each occasion the aggregated output indicates an attack; and
triggers the alarm if the count exceeds a predetermined threshold.

8. The sensor fabric of claim 1, wherein the aggregator aggregates the outputs based on spatial proximity of the respective cluster.

9. The sensor fabric of claim 1, wherein a spacing between nearest ones of the photodetectors is defined based on a predetermined laser spot size.

10. The sensor fabric of claim 9, wherein the spacing comprises placing a photodetector every N_{gate pitch} gate pitches from a centre of a said transistor footprint such that:
$${N}_{gate pitch} \leq {w}_{laser} / CGP = 1.7 \cdot FWHM / CGP$$
where Wlaser is the laser spot width, CGP is a contacted gate pitch and FWHM is a full-width at half-maximum power.

11. The sensor fabric of claim 1, further comprising inserting one or more dummy transistors for each photodetector, to maintain a geometry of the respective group of the photodetectors.
